(19) United States
(12) Patent Application Publication
(10) Pub. No.: US 2003/0167567 A1
(43) Pub. Date: Sep. 11, 2003

(54) Invalid lifting apparatus

(76) Inventor: Edward Reed, Swansea (GB)

Correspondence Address: WADDEY & PATTERSON, 414 UNION STREET, SUITE 2020, BANK OF AMERICA PLAZA, NASHVILLE, TN, 37219

(21) Appl. No.: 10/276,616

(22) PCT Filed: May 17, 2001
(86) PCT No.: PCT/GB01/02176

(30) Foreign Application Priority Data
May 18, 2000 (GB) 0011836.4

(51) Int. Cl. A61G 7/10

(52) U.S. Cl. 5/86.1

(57) ABSTRACT

A hoist for lifting a person includes support wheels, a steering arrangement and a drive arrangement including a motive driven wheel (or wheels) for engaging the ground surface.

The present invention is concerned with apparatus for lifting, hoisting and handling of invalids or patients (including disabled, elderly or otherwise infirm persons), and a carriage assembly for use with such invalid lifting apparatus. Such apparatus is typically for use in combination with an invalid lifting sling or the like.

Various types of apparatus are known for lifting, hoisting and handling of invalids and other patients. Examples of such apparatus are disclosed in WO97/17048 and in U.S. Pat. Nos. 5,185,895, 5,369,821, 5,682,630, 5,784,729, 5,845,348 and 5,987,664.

Such known types of apparatus are often difficult to manoeuvre, and they generally only permit lifting and lowering of an invalid, and also a swinging movement by permitting pivotting about a support structure or the like.

It is an object of the invention to provide improved apparatus for lifting invalids or patients, which provide greater flexibility of movement for manoeuvring the invalid or patient.

According to the present invention, there is provided lifting apparatus comprising:

a hoist arrangement for lifting a person;

one or more ground engaging support members facilitating movement of the hoist arrangement over ground surface;

steering means permitting steering of the apparatus; and

driving means including one or more motive driver member (preferably a driving wheel) for engaging the ground surface and driving the apparatus over the ground surface.

The present invention further comprises a ground engageable carriage assembly for coupling with and controlling movement of a mobile invalid hoist arrangement, the carriage comprising:

i) driving means including one or more motive driving members for engaging the ground surface; and

ii) steering means permitting steering of the carriage assembly and coupled hoist arrangement.

In one embodiment, the apparatus includes rotatable support members (such as wheels or casters) and preferably:

a base frame:

at least one upright post fixable to the base frame; an arm member having a proximal portion arranged to be secured to the post so as to project transversely therefrom;

invalid support means arranged to be coupled to a distal portion of the arm member;

winch means for selectively raising or lowering the distal portion; and the driving means comprises:

a ground-engageable carriage assembly fixable either to the post or to the base frame, the carriage assembly comprising at least one drivable ground engaging member (preferably a pair, such as a pair of wheels), motorised drive means for driving said ground engaging member, and handle means arranged to extend upwardly from the carriage assembly and arranged to steer said ground-engageable member and to control said drive means.

The carriage assembly preferably includes a base frame and a winch arrangement fixable to the base frame, the carriage assembly having at least one driveable pair of ground-engageable members (such as wheels), motorised drive means for driving said ground-engageable members, and handle means arranged to extend upwardly from the carriage assembly, said handle means being arranged to permit steering of said ground-engageable members and operational control of said drive means.

The drive means typically includes a motor and a gearbox for transmitting motion of the motor to the ground-engageable members. The motor may be disengageable from the ground-engageable members, such that (when the latter are wheels) they are permitted to freewheel.

It is preferred that each of the driveable pair of ground-engageable members is a pair of wheels of substantially greater diameter (such as at least four times the diameter) than the wheels provided on the base frame. It is further preferred that the driveable pair of wheels is mounted on an axis substantially parallel to a plane of the base frame. The driveable wheels are typically provided with tyres, which may be of solid or pneumatic type. Alternatively, the ground-engageable members maybe tracked drive rather than wheels.

The handle means typically includes a shaft arranged to extend upwardly and outwardly from the driveable pair of wheels (and therefore away from the base frame). The shaft is typically telescopically adjustable, so that the length thereof can be selectively increased or decreased.

At an end of the shaft remote from the driveable ground-engageable members, the handle means is preferably provided with a handlebar for permitting rotation of the shaft and thereby to cause turning of the driveable ground-engageable members. Such a handlebar is typically for two-handed operation, and preferably includes spaced hand grips, one disposed on either side of the shaft.

The hand grips (which may each be of a type corresponding to those conventionally used on motor cycles or the like) may be further provided with hand grips or the like, typically for controlling respective forward and reverse rotation of the driveable ground-engageable members. The control from the hand grips may be of conventional cable operation, or it may be suitable for microswitch operation or the like.

The shaft is typically mounted to the carriage assembly by a flexible mounting, such that the distal end of the shaft can be selectively raised or lowered.

The motorised drive means provided on the carriage assembly preferably includes an electric motor or the like; an electric power supply (such as a battery) for the electric motor is typically provided either on the carriage assembly or on the base frame.

The carriage assembly is preferably provided with a rigidly mounted upright, preferably dimensioned to permit connection to the upright post when the latter is fixed to the base frame. Preferably a clamp (which is typically of an adjustable nature) is provided to permit secure fixing of the upright to the post.

An embodiment of the present invention will now be described, by way of example only, with reference to the accompanying drawings, in which:

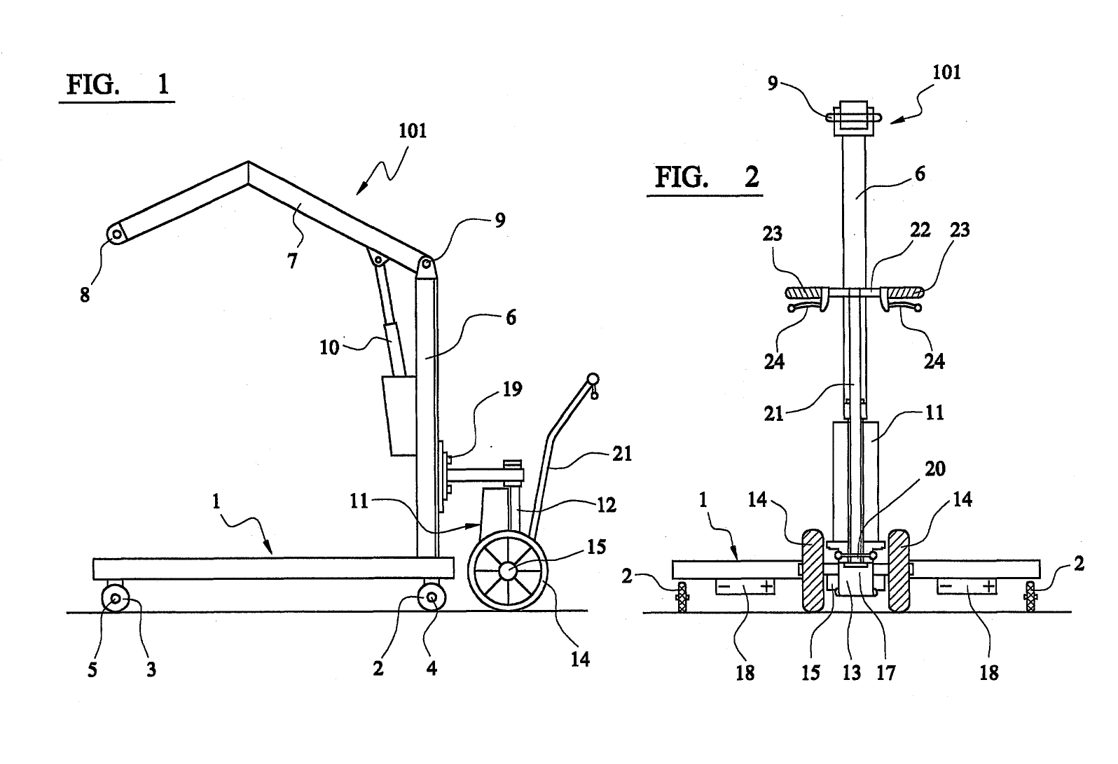

FIG. 1 shows a schematic side elevation of exemplary apparatus according to the invention; and

FIG. 2 shows an end elevation of the apparatus shown in FIG. 1.

Referring to FIGS. 1 and 2 of the accompanying drawings, there is shown a hoist 101 including a base frame 1, having two pairs of wheels 2,3 mounted for rotation on axles 4,5. A first pair of wheels 2 is mounted at a first (proximal) end of the base frame (see FIG. 2); a second pair of wheels 3 is mounted at a distal end of the base frame.

At a proximal end of the base frame 1 is mounted an upright post 6; at the upper end of the post is mounted an arm 7 having an eye 8 at its distal end, suitable for mounting a hook or the like on which an invalid support sling or cradle can be suspended. The arm 7 is mounted to the post via a pivot connection 9, and post 6 is further connected to the arm via an hydraulic ram 10, the latter being arranged to selectively extend or retract, so as to thereby raise or lower the arm 7 in the manner of a winch.

Fixed to the post 6 is a carriage 11, which includes an upright 12, the latter being mounted on a trolley 13 having a pair of wheels 14, both wheels 14 being mounted on an axle 15. Also mounted on carriage 11 is a motor 16, which is typically an electric motor, which is connected via a gearbox 17 to both of the pair of wheels. The electric motor is powered by a suitable battery supply; in the embodiment shown, a pair of batteries 18 is mounted to the underside of the base frame. Such batteries 18 in the embodiment are also arranged to power the hydraulic ram 10. Preferably, switching (not shown)is provided to permit the power supply to switch from the ram to the motor, and vice versa. The upright 12 is fixed to post 6 via a bracket 19.

The wheels 13,14 and axle 15 arrangement preferably include a dog clutch arrangement permitting selective activation of a free wheeling mode in which wheels 13,14 can rotate independently of the turning motor 16 shaft. This permits the hoist to be wheeled independently of operation of the motor, for example quickly between hospital wards when a patient is not supported by the hoist. Alternatively bracket 19 may be replaced by a pivoting bracket or mechanism permitting pivoting of the carriage from a wheels 13,14 engaging ground position, to a stowed raised position, with wheels 13,14 lifted from engagement with ground surface.

Carriage 11 has mounted thereon, via flexible connection 20, a shaft 21 having a crosspiece handlebar 22 at the free end thereof. At each end of handlebar 22 is a respective handgrip 23; each handgrip further includes a respective cable operating lever 24 connected via a cable (not shown) to control the motor 16.

The motorised carriage assembly is provided to permit drive of the structure including the base frame, the post and the arm, so that the whole apparatus can be more easily manouevred both in the absence of a patient and, moreover, when a patient is suspended from a sling or the like which is attached to the distal end of the arm.

The motorised carriage assembly is preferably such that it can be used as a retrofit accessory to a wheeled invalid lifting apparatus of known type. The mobile hoist preferably includes an emergency shutdown or alarm facility arranged to be activated when or if the hoist is subjected to a load exceeding a predetermined threshold. The shutdown facility may inhibit operation of the drive motor or wheels and/or operate an audible or visible alarm.

1. Invalid lifting apparatus comprising:
a hoist arrangement for lifting a person;
one or more ground engaging support members facilitating movement of the hoist arrangement over ground surface;
steering means permitting steering of the apparatus; and
driving means including one or more motive driven members (preferably one or more driving wheels) for engaging the ground surface and driving the apparatus over the ground surface.

2. Invalid lifting apparatus according to claim 1, wherein the driving means is demountable from and remountable to the hoist arrangement.

3. Invalid lifting apparatus according to claim 1 or claim 2, wherein the driving means is reconfigerable between a stowed position in which the motive driven member is in a stowed position not engaging the ground, and an operational position engaging the ground for driving movement.

4. Invalid lifting apparatus according to any preceding claim, wherein the driving means is configurable in:
i) free wheel mode in which the motive driven member free wheels on the ground or is lifted from the ground; and
ii) driving mode for driving the apparatus over the ground surface.

5. Invalid lifting apparatus according to any preceding claim including motive power means for driving the driven member.

6. Invalid lifting apparatus according to any preceding claim, including manually actuable control means for controlling operation of the driving means to supply motive driving power.

7. Invalid lifting apparatus according to any preceding claim, wherein motive power for the driving means is provided by a battery (preferably rechargeable).

8. Invalid lifting apparatus according to any preceding claim, wherein the driving means includes a motor (such as an electric motor) for driving the motive driven member.

9. Invalid lifting apparatus according to any preceding claim, wherein the hoist arrangement comprises:
a base frame:
at least one upright post fixable to the base frame;
an arm member having a proximal portion arranged to be secured to the post so as to project transversely therefrom;
invalid support means arranged to be coupled to a distal portion of the arm member;
winch means for selectively raising or lowering the distal portion; and the driving means comprises:
a ground-engageable carriage assembly fixable either to the post or to the base frame, the carriage assembly comprising at least one drivable ground engaging member (preferably a pair, such as a pair of wheels), motorised drive means for driving said ground engaging member, and handle means arranged to extend upwardly from the carriage assembly and arranged to steer said ground-engageable member and to control said drive means.

10. Invalid lifting apparatus according to any preceding claim, wherein the driving means includes a motor and a gearbox for transmitting motion of the motor to the ground-engageable driving member.

11. Invalid lifting apparatus according to any preceding claim, wherein the driving ground-engageable member is or includes a driving wheel of substantially greater diameter (such as at least four times the diameter) than the wheels supporting the hoist arrangement.

12. Invalid lifting apparatus according to any preceding claim, wherein the handle means typically includes a shaft arranged to extend upwardly and outwardly from the motive driven support member (wheel) and therefore away from a base frame of the hoist arrangement.

13. Invalid lifting apparatus according to claim 12, wherein the shaft is telescopically adjustable, so that the length thereof can be selectively increased or decreased.

14. Invalid lifting apparatus according to any preceding claim, wherein the motive driven member is drivable in forward and reverse directions.

15. Invalid lifting apparatus according to any preceding claim, wherein the motive driven member is controlled by hand grips, or triggers or switches associated with the steering means.

16. Invalid lifting apparatus according to claim 15, wherein the control from the hand grips or triggers switches or is of conventional cable operation, or of suitable microswitch operation or the like.

17. Invalid lifting apparatus according to any preceding claim, wherein emergency shut down means is provided:
i) inhibiting operation of the driving means to prevent motive driving of the driven member; and/or
ii) operating alarm means (audible or visible);
the shutdown means being activated when or if the hoist is subjected to a load at not exceeding a predetermined threshold level.

18. A ground engageable carriage assembly for coupling with and controlling movement of a mobile invalid hoist arrangement, the carriage comprising:
i) driving means including one or more motive driving members for engaging the ground surface; and
ii) steering means permitting steering of the carriage assembly and coupled hoist arrangement.
